(19) United States
(12) Patent Application Publication
(10) Pub. No.: US 2026/0367948 A1
(43) Pub. Date: Nov. 19, 2026

(54) INTERACTIVE SYSTEM FOR VISUAL GUIDANCE WITH GENERATIVE MODEL OUTPUT

(71) Applicant: GDM Holding LLC, Mountain View, CA (US)

(72) Inventors: Claudio Martella, Amsterdam (NL); Jasmin Repenning, Hamburg (DE); Caitlin Sikora, Brooklyn, NY (US); Santiago Lopez, Barcelona (ES); Przemyslaw Szczepaniak, London (GB); Igor Mordatch, Oakland, CA (US); Vivek Kesarwani, Toronto (CA); Lei Shu, Kirkland, WA (US); Fedir Zubach, Zurich (CH); Genzhi Ye, Palo Alto, CA (US); Peter Zhizhin, Berlin (DE); John Penington, New York, NY (US); Jindong Chen, Hillsborough, CA (US); Shubham Milind Phal, Mountain View, CA (US); Mahesh Ramachandran, Dublin, CA (US); David Joseph Tan, Zurich (CH); Bhanu Prakash Reddy Guda, Sunnyvale, CA (US); Renhao Liu, Mountain View, CA (US); Pavel Dubov, London (GB); Chen Yan, London (GB); Jonas Degrave, London (GB); Reed Roberts, London (GB); Mauro Rego, Berlin (DE); Alejandra Molina, New York, NY (US); Miguel de Andrés-Clavera, Singapore (SG); Cheng Ji, Shanghai (CN); Agata Dondzik, Melbourne (AU); Edwina Priest, Singapore (SG); Stefan Mellem, Woodinville, WA (US)

(21) Appl. No.: 19/677,315

(22) Filed: May 14, 2026

Related U.S. Application Data
(60) Provisional application No. 63/808,284, filed on May 19, 2025.

(51) Int. Cl. G06F 9/451; G06F 16/3329; G06T 7/70

(52) U.S. Cl. CPC G06F 9/453; G06F 16/33295; G06T 7/70

(57) ABSTRACT

Implementations provide interactive visual feedback in a multimodal interactive session. A natural language query and an image are received. Based on processing the query and image with generative models, output is generated. The output includes responsive natural language content and overlay content characterizing an object for a visual overlay. The client device renders the responsive natural language content and the visual overlay. The visual overlay is rendered in accordance with the object characterized by the overlay content and is displayed over an interface or a stream of images captured by a camera.

### BACKGROUND

Various techniques have been proposed for utilizing generative models in processing natural language (NL) queries to generate output for responding verbally or textually to such NL queries. In generating such output for an NL query, some systems can additionally process, using a generative model and along with the NL query, visual information that characterizes content from a camera or screen share. For example, in the case of a generative model that accepts multimodal inputs, the visual information can include image(s) from the camera and/or screenshot(s) from the screen share. As another example, the visual information can additionally or alternatively include NL description of object(s) detected (e.g., using a separate machine learning (ML) model) from image(s) from the camera and/or from screenshot(s) from the screen share.

However, a limitation of various techniques is that generated output includes only NL output. Such natural language output can be ambiguous, particularly in complex visual environments or when describing objects that are not easily distinguishable by simple terms. Users may struggle to correlate the verbal description with the specific object in their view, leading to potential confusion, a less intuitive user experience, and/or prolonging of a human to computer interaction.

As one example, a camera of a mobile phone can be used to capture an image containing electronic components such as resistors (including a 3K resistor), capacitors, and a circuit board. A user could then ask, via an NL query, how to assemble a circuit to achieve a particular function. The NL query and the image can be processed, using a generative model, to generate output that is limited to NL such as output of “first pick up the 3K resistor”. Providing only natural language output in that and other situations presents challenges. For example, it can take an extended amount of time for a user to identify the 3K resistor from amongst multiple different resistors in the environment, delaying provision of next steps by the system and prolonging the human to computer interaction.

### SUMMARY

Implementations disclosed herein are directed to providing interactive visual feedback within a multimodal interaction session. Those implementations facilitate generating a visual overlay that corresponds to an NL query and an image, such as a screenshot of a user interface or a camera feed image, to guide a human to computer interaction, enhance the clarity and responsiveness of a system's output, and/or shorten a duration of the human to computer interaction.

As opposed to generating and providing only NL output in response a user request that is directed to a camera feed or to a rendered interface, implementations disclosed herein selectively generate and provide a visual overlay for rendering over the camera feed or the rendered interface. For example, when generated NL output, that is responsive to an NL query of a user, includes description of an object that is present in an image provided with the NL query, the system can additionally cause a visual overlay to be rendered along with generated NL output and in association with the object. For instance, when the image is from a camera feed, augmented reality techniques can be utilized to render the visual overlay over the object in subsequent images from the camera feed. However, various implementations will not provide any visual overlay when generated NL output, that is responsive to an NL query of a user, does not include description of any object that is present in an image provided with the NL query. In these and other manners, implementations seek to provide a visual overlay in situations where that overlay can assist a user in understanding a generated NL response more quickly and/or more accurately, while also seeking to omit provision of any visual overlay where the generated NL response can be understood by a user without use of such visual overlay and/or where the response does not relate to any object visible in the image.

In various implementations, the object to which the visual overlay corresponds can be one that is directly reflected in the generated NL output but that is not directly reflected in the NL query. For example, a camera feed can be capturing a circuit board and multiple electronic components and the NL query can be “what do I need to connect next”, the generated NL output can be “the 3K resistor”, and the visual overlay can be rendered in association with a 3K resistor that is captured in image(s) from the camera feed. As another example, a camera feed can be capturing multiple boxes of food items, the NL query can be “which one of these has the most fiber”, the generated NL output can be “the Brand X box”, and the visual overlay can be rendered in association with the box corresponding to “the Brand X box”.

As a non-limiting example of some implementations disclosed herein, assume a user utilizes a mobile phone with a camera to identify a specific component on a circuit board. The user opens an application, such as a technical assistance application, on the phone. The camera of the phone is pointed at the circuit board, and the application displays a live feed of the camera view. The user provides an NL query to the application, for instance, “Where is the 3K resistor?”. This NL query is generated based on the user's speech input via the phone's microphone. The NL query (e.g., audio data captured via the microphone and/or an automatic speech recognition of the speech) and the image from the camera are transmitted from the client device to a server device over a network. In response to receiving the query and the image, the server device processes these inputs using one or more generative models to generate output that includes responsive natural language content, such as “The 3K resistor is located near the center of the board,” and overlay content that characterizes the location of the identified 3K resistor in the image. This overlay content might include coordinate(s) corresponding to the identified 3K resistor, such as pixel coordinate(s) in the image. The server device then transmits this output back to the client device. The client device receives the output and, in response to the NL query, renders the responsive NL content as text and/or synthesized speech, and simultaneously renders a visual overlay. This visual overlay, such as a bounding box or a marker, is rendered over the live camera feed displayed on the phone's screen, specifically highlighting the 3K resistor characterized by the received overlay content. This visual guidance helps the user quickly locate the specific component on the circuit board, facilitating the user's task, such as assembling or repairing the circuit, and enhancing the efficiency of the human-computer interaction.

Although the preceding example is described with respect to a server device performing some functions and being separate from a client device, in various implementations some or all of those functions can instead be performed at the client device. For example, the client device can process the NL query and the image(s) using generative model(s) to generate output that includes responsive natural language content, such as “The 3K resistor is located near the center of the board,” and to generate overlay content that characterizes the location of the identified 3K resistor in the image. In such an example, the server functions can be omitted and transmissions to/from the server can be omitted. Further, in such an example the generative model(s), utilized to generate responsive natural language content and/or overlay content, can be stored locally at the client device and utilized in processing locally at the client device.

Some implementations disclosed herein include a system that includes one or more processors configured to perform operations. The operations include receiving an NL query and an image during an interactive session. The image is a screenshot of an interface being rendered by a client device or is captured by a camera of the client device. The image can be provided along with the NL query based on prior user input that indicates screenshot(s) and/or a camera feed image(s) should be processed and/or based on a determination (e.g., locally at a client device) that the NL query relates to an active interface and/or to a camera feed. In response to receiving the NL query and the image, and during the interactive session, the system generates output using one or more generative models. The generated output includes responsive NL content corresponding to the query and overlay content characterizing an object for a visual overlay. The system causes the client device to render the responsive NL content and the visual overlay during the interactive session. The visual overlay is rendered according to the characterized object and is displayed over the interface or a stream of images captured by the camera.

Generating the output can involve generating an initial prompt that includes the NL query and the image and processing the initial prompt with a generative model to produce initial output. The initial output can reflect the responsive NL content and an NL description of an object in the image addressed by the query. Based on this NL description and the image, the system processes these inputs with the same or an additional generative model to generate the overlay content that characterizes the area for the visual overlay. Alternatively, a prompt including the NL query and the image is processed by a generative model to directly generate output reflecting both the responsive natural language content and the overlay content. These prompts can include instructional language guiding the generation of the description or the overlay content.

When the image is captured by a camera, the client device can render the visual overlay over the object in a subsequent stream of images from the camera. The client device can utilize the overlay content to track the object in the stream and adjust the visual overlay's rendering accordingly, employing marker-less tracking, marker-based tracking, and/or other object tracking technique(s).

The client device can monitor for conditions indicating that the visual overlay is no longer needed or appropriate, such as the object no longer being present in the interface or image stream, expiration of a rendering duration, or occurrence of a dismissal user interface input. In response to detecting such a condition, the client device can cease rendering the visual overlay.

The client device can additionally or alternatively dynamically adjust the visual features of the visual overlay based on the detected size of the object in the interface or image stream. For instance, the visual overlay can be rendered with a bounding shape encompassing the object when the object satisfies a threshold size, and with a dot over the object when the object does not satisfy the threshold size. The visual overlay can be a bounding shape, an arrow pointing to the object, or a dot over the object. In some implementations, the visual overlay can lack any natural language content. Additional or alternative visual overlay(s) can be utilized. For example, a visual overlay could include some text (e.g., “here” to denote location of an object), could include an outline of an object, a rendering of an object, and/or other visual content.

The overlay content can include a coordinate corresponding to a pixel of the image. The client device can use this coordinate and the image to track the object's position and dynamically adjust the visual overlay's positioning.

The system supports continued interaction during the interactive session. While a visual overlay is rendered, the system can receive an additional NL query and an additional image. This additional input can lead to generating additional output, including additional responsive NL content and either additional overlay content for another object or an indication that a visual overlay is not to be applied. The client device then renders the additional content and either applies the visual overlay to the additional object or ceases rendering the current visual overlay.

A method implemented by one or more processors of a client device includes providing a natural language query and an image to a server device during an interactive session. The method includes receiving output from the server device that includes responsive natural language content and overlay content characterizing an object. The method further includes rendering the responsive natural language content and the visual overlay in accordance with the characterized object, over the interface or a rendered stream of camera images. The client device method encompasses the dynamic rendering adjustments, tracking, and monitoring for conditions to cease rendering as described for the system.

A device comprises memory storing instructions and one or more processors operable to execute the instructions to perform method(s) described herein. A transitory or non-transitory computer-readable medium comprises instructions that, when executed, cause a device to perform method(s) described herein.

Generative models can take various forms, including, but not limited to, model(s) such as Gemini, Flamingo, PaLM, BERT, LaMDA, Meena, and/or any other single-modal or multimodal generative model, such as any other generative model that is encoder-decoder-based, encoder-only based, decoder-only based, sequence-to-sequence based and that optionally includes an attention mechanism or other memory, diffusion model(s), etc. For example, generative model(s) described herein can include multi-modal input models that can process multiple modalities of input, such as a vision language model (VLM). Generative models can have hundreds of millions, or even hundreds of billions of parameters, and the numbers of parameters is likely to increase dramatically as computational efficiency and/or resources improve.

Some implementations include a non-transitory computer readable storage medium storing instructions executable by a processor to perform a method such as one or more of the methods described herein. Some implementations include a system including memory and one or more processors operable to execute instructions, stored in the memory, to implement one or more modules or engines that, alone or collectively, perform a method such as one or more of the methods described herein.

The preceding is provided as an overview of only some implementations disclosed herein. Those and implementations are described in more detail herein.

### BRIEF DESCRIPTION OF THE DRAWINGS

FIG. 1 is a block diagram illustrating components of an example system that provides interactive visual feedback in a multimodal session.

FIG. 2 is a diagram illustrating example interactions between components of FIG. 1.

FIG. 3A, FIG. 3B, FIG. 3C, and FIG. 3D illustrate a client device and part of an example interactive session according to implementations disclosed herein.

FIG. 4 is a flowchart illustrating an example method according to implementations disclosed herein.

FIG. 5 is a flowchart illustrating another example method according to implementations disclosed herein.

FIG. 6 is a block diagram illustrating example hardware components of a computing system.

### DETAILED DESCRIPTION

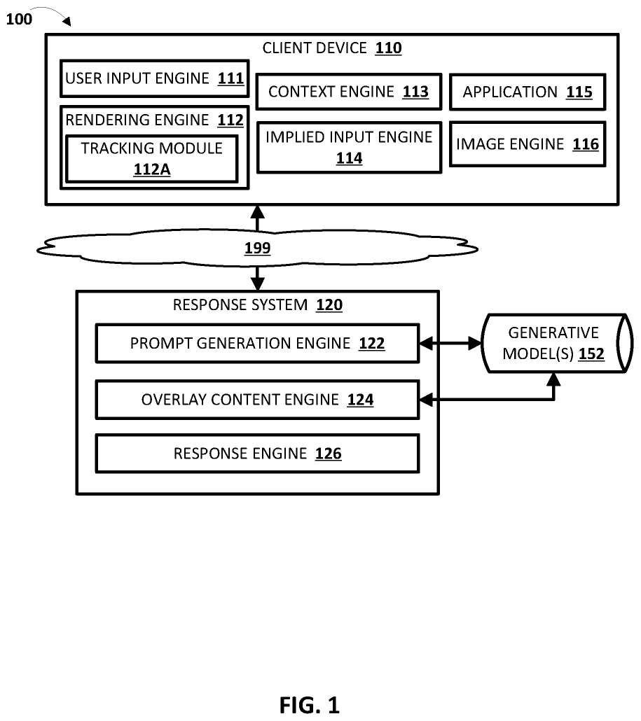

FIG. 1 depicts a block diagram of an example system 100 that provides interactive visual feedback in a multimodal session. The example system 100 includes a client device 110 and a response system 120. The example system 100 can also include one or more networks 199 facilitating communication between the client device 110 and the response system 120. Although depicted separately, in some implementations all or aspects of the client device 110 and the response system 120 can be implemented as part of a single device or system.

In some implementations, all or aspects of the response system 120 can be implemented locally at the client device 110. In additional or alternative implementations, all or aspects of the response system 120 can be implemented remotely from the client device 110 as depicted in FIG. 1 (e.g., at one or more remote server(s)). In those implementations, the client device 110 and the response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of a user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which requests can be submitted and/or via which output(s) that include responsive content generated by one or more generative model(s) and/or other response(s) to the requests can be rendered (e.g., audibly and/or visually). Application 115 can be an application that is separate from an operating system of client device 110 (e.g., one installed “on top” of the operating system)- or can alternatively be implemented directly by the operating system of client device 110. For example, application 115 can be a web browser installed on top of the operating system, or can be an application that is integrated as part of the operating system functionality. Application 115 can interact with the response system 120. In some implementations, the application 115 can interact with additional application(s) in submitting requests to the response system 120 and/or in rendering output of the response system 120. For example, an image that is a screenshot of an interface being rendered by an additional application can be provided to the response system 120 as part of a request and a visual overlay, that is reflected by a response provided by the response system 120, can be rendered over the interface of the additional application. For instance, the application 115 can render the visual overlay over the interface being rendered by the additional application (e.g., a web browser or other application).

In various implementations, client device 110 can include a user input engine 111 that is configured to detect user input provided by a user of client device 110 using one or more user interface input devices. For example, client device 110 can be equipped with one or more microphones that capture audio data, such as audio data corresponding to spoken utterances of the user or other sounds in an environment of client device 110. Additionally, or alternatively, client device 110 can be equipped with one or more vision components (e.g., camera(s)) that are configured to capture images detected in a field of view of one or more of the vision components. Additionally, or alternatively, client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to client device 110. Some instances of a natural language query described herein, that can be included in a request, can be a query that is formulated based on user input provided by a user of client device 110 and detected via user input engine 111. For example, the natural language query can be a typed query that is typed via a physical or virtual keyboard, a suggested query that is selected via a touch screen or a mouse, a spoken voice query that is detected via microphone(s) of the client device, and/or a predicted transcription (e.g., using a local speech recognition engine of the client device 110) of a spoken voice query that is detected via microphone(s) of the client device.

In various implementations, client device 110 can include a rendering engine 112 that is configured to provide responsive natural language content (e.g., natural language based content generated by a generative model) for audible and/or visual presentation to a user of client device 110 using one or more user interface output devices. For example, client device 110 can be equipped with one or more speakers that enable content to be provided for audible presentation to the user via client device 110. Additionally, or alternatively, client device 110 can be equipped with a display or projector that enables content to be provided for visual presentation to the user via client device 110. Rendering engine 112 can further be configured to render a visual overlay when response system 120 directs the client device 110 to render a visual overlay. The visual overlay can be rendered over an interface of an application of a client device (e.g., rendered over a webpage being displayed by an Internet browser, rendered over an interface being displayed by a ridesharing application, etc.) and/or over a rendered stream of images captured by a camera of the client device (e.g., a live stream of the images can be rendered via the application 115). The visual overlay can correspond to an object that is rendered in the interface of the application or that is rendered in image(s) from the camera, and the visual overlay can be rendered in accordance with rendering of the object. For example, the visual overlay can be rendered over the object, can be rendered so that it encompasses the object, can be rendered pointing to the object, and/or can be rendered in some other manner with respect to the object.

In various implementations, rendering engine 112 can include a tracking module 112A that is configured to perform object tracking within a stream of images. For example, tracking module 112A can track an object for which a visual overlay is being rendered, such as an object that is captured in a stream of images from a camera as described herein. In some implementations, the tracking module 112A can, in tracking an object, utilize one or more object tracking techniques such as marker-less tracking or marker-based tracking. Tracking module 112A can work in conjunction with rendering engine 112 to dynamically adjust a rendering position of a visual overlay as the tracked object moves within the image stream.

In various implementations, client device 110 can include a context engine 113 that is configured to determine a context (e.g., current or recent context) of client device 110 and/or of a user of client device 110. In some of those implementations, context engine 113 can determine a context utilizing current or recent interaction(s) via client device 110, a location of client device 110, profile data of a profile of a user of client device 110 (e.g., an active user when multiple profiles are associated with client device 110), and/or other data accessible to context engine 113. For example, context engine 113 can determine a current context based on a current state of a query session (e.g., considering one or more recent queries of the query session), profile data, and/or a current location of client device 110. For instance, context engine 113 can determine a current context of “looking for a healthy lunch restaurant in Louisville, Kentucky” based on a recently issued query, profile data, and a location of client device 110. As another example, context engine 113 can determine a current context based on which application is active in the foreground of client device 110, a current or recent state of the active application, and/or content currently or recently rendered by the active application. A context determined by context engine 113 can be utilized, for example, as part of a prompt described herein. For example, a natural language representation of the context can be included in a prompt along with a natural language query and an image. A context determined by context engine 113 can additionally or alternatively be utilized, for example, in supplementing or rewriting a query that is formulated based on user input, in generating an implied query (e.g., a query formulated independent of user input), and/or in determining to submit an implied query and/or to render result(s) (e.g., generative model generated response) for an implied query.

In various implementations, client device 110 can include an implied input engine 114 that is configured to: generate an implied query independent of any user input directed to formulating the implied query; to submit a request that includes the implied query, optionally independent of any user input that requests submission of the request; and/or to cause rendering of a response for an implied query, optionally independent of any user input that requests rendering of the response. For example, implied input engine 114 can use current context, such as current location and/or current query, from current context engine 113, in generating an implied query, determining to submit a request that includes the implied query, and/or in determining to cause rendering of a response for the implied query. For instance, implied input engine 114 can automatically generate and automatically submit an implied query based on the current context. Further, implied input engine 114 can automatically push a response to the implied query to cause the response to be automatically rendered or can automatically push a notification of the response, such as a selectable notification that, when selected, causes rendering of the response. As another example, implied input engine 114 can generate an implied query based on profile data (e.g., an implied query related to an interest of a user), submit the query at regular or non-regular intervals, and cause a corresponding response to be automatically provided (or a notification thereof automatically provided).

In various implementations, client device 110 can include an image engine 116 that is configured to capture or otherwise obtain one or more images for use by response system 120. For example, image engine 116 can obtain image data from a camera of client device 110 or from a screenshot of an interface being rendered by client device 110.

Further, client device 110 and/or response system 120 can include one or more memories for storage of data and/or software applications, one or more processors for accessing data and executing the software applications, and/or other components that facilitate communication over one or more of networks 199. In some implementations, one or more of the software applications can be installed locally at client device 110, whereas in other implementations one or more of the software applications can be hosted remotely (e.g., by one or more server(s)) and can be accessible by client device 110 over one or more of networks 199.

Although aspects of FIG. 1 are illustrated or described with respect to a single client device 110 having a single user, it should be understood that is for the sake of example and is not meant to be limiting. For example, one or more additional client devices of a user and/or of additional user(s) can also implement the techniques described herein. For instance, client device 110, the one or more additional client devices, and/or any other computing devices of a user can form an ecosystem of devices that can employ techniques described herein. These additional client devices and/or computing devices may be in communication with client device 110 (e.g., over network(s) 199). As another example, a given client device can be utilized by multiple users in a shared setting (e.g., a group of users, a household).

Response system 120 is illustrated as including a prompt generation engine 122, an overlay content engine 124, and a response engine 126. Some of the engines can be omitted in various implementations. Response system 120 can utilize one or more generative models (GM(s)) 152 in its operations.

In response to receiving a request from client device 110, which can include a natural language query and one or more images, prompt generation engine 122 can generate a prompt for processing by one or more generative models 152.

Prompt generation engine 122 can generate the prompt by including the natural language query and the image(s) received in the request. The prompt can also optionally include instructional language and/or further context such as content from search result(s) determined to be responsive to the request, content from context document(s) indicated by user interface input as relevant, context data from the client device 110, and/or other context.

The prompt can be processed using one or more of the generative model(s) 152 can process the prompt to generate initial output. The initial output can include responsive natural language content that is responsive to the natural language query. In some implementations, the initial output can also include a natural language description of an object that is in the image(s) and is addressed by the responsive natural language content.

If the initial output reflects an object for a visual overlay, overlay content engine 124 can generate overlay content that characterizes the object to which a visual overlay is to be applied. This can involve, for example, processing the natural language description of the object, and the image, using one or more of the generative model(s) 152, which can be the same as or different from the GM(s) 152 used in generating the initial output. The generate overlay content can include data such as coordinate(s) corresponding to the object in the image(s). For example, the overlay content can include an X, Y coordinate that reflects a pixel in the image. As another example, the overlay content can include four X, Y coordinates that collectively define the corners of a bounding box that encompasses the object in the image. As yet another example, the overlay content can include an identifier of all of the pixels, in the image, that collectively define a mask of the object in the image. As described herein, the rendering engine 112 can utilize the overlay content in determining where and how to render the visual overlay in the image and/or in additional images of a stream of images or additional images that are screenshots of an interface.

Response engine 126 can generate responsive content for the request. This responsive content can include the responsive natural language content from the initial output. If overlay content is generated by overlay content engine 124, response engine 126 can also include or reference this overlay content in the responsive content sent to client device 110.

Response system 120 can then cause client device 110 to render the responsive content. This can include causing client device 110 to render the responsive natural language content (e.g., audibly and/or visually) and, if overlay content is provided, to render a visual overlay in accordance with the object characterized by the overlay content. The visual overlay can be rendered over the interface displayed by client device 110 or over a rendered stream of images captured by a camera of client device 110. In some implementations, causing client device 110 to render the responsive content can include sending the responsive content to client device 110 via one or more of networks 199.

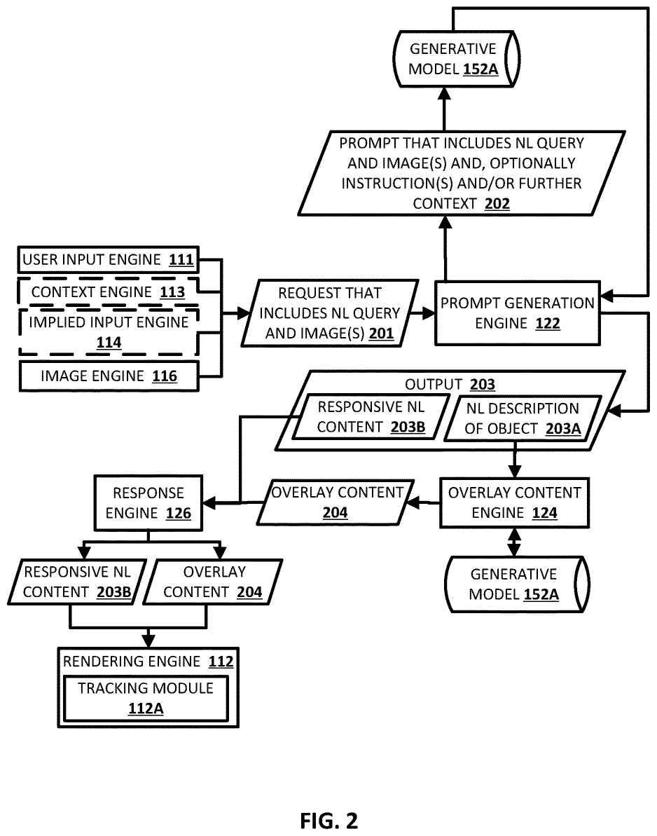

Turning now to FIG. 2, a non-limiting example is provided of interactions that can occur between various components of system 100 in generating, in response to a request that includes a NL query and image(s), responsive NL content and overlay content, and causing the responsive NL content and the overlay content to be rendered.

FIG. 2 illustrates a non-limiting example of data flow between various components of system 100 in generating, in response to a request that includes a natural language query and image(s) 201, responsive natural language content 203B and overlay content 204, and causing the responsive NL content 203B and the overlay content 204 to be rendered.

A request that includes NL query and image(s) 201 can be generated based on at least user input engine 111 and image engine 116 and, optionally, context engine 113 and implied input engine 114. For example, at least some of the NL query can be generated based on output from user input engine 111 that is based on user interface input from a user of client device 110. Further, the image(s) can be based on output from image engine 116 and can be image(s) from a camera of client device 110 or can be screenshots capturing an interface being rendered by the client device 110. The request 201 can optionally further include additional content, such as additional portions of the NL query, that are based on context data generated by context engine 113 and/or implied input generated by implied input engine 114.

Prompt generation engine 122 generates a prompt 202 that includes the natural language query and image(s) from the request 201, and can optionally include instruction(s) and/or further context. For example, the prompt 202 can further include instructional language to generate a description of an object that is in the image(s) and that is addressed by the natural language content. For instance, the instructional language can be of the form “In addition to replying with natural language content, a reply can include a visual overlay on the image to highlight what the natural language content is describing. The visual overlay should be used only if it will be helpful in understanding the natural language content. The visual overlay will be generated using a tool that processes a description of what you are talking about. Accordingly, output “overlay:” followed by a natural language description of what you are talking about if the visual overlay should be used.” As another instance, the instructional language can be of the form “In addition to replying with natural language content, a reply can include a visual overlay on the image to highlight what the natural language content is describing. The visual overlay should be used only if it will be helpful in understanding the natural language content. Accordingly, if a visual overlay should be used output a natural language description of where, in the image, the visual overlay should be focused.”

The prompt 202 is processed by generative model 152A to generate output 203. The output 203 can reflect a natural language description of object 203A (e.g., based on the instructional language) and responsive natural language content 203B. Overlay content engine 124 generates overlay content 204 that characterizes the object to which a visual overlay is to be applied. This can involve processing the natural language description of object 203A and the image(s) (not depicted for simplicity), using the generative model 152A or an additional generative model (not explicitly shown but encompassed by generative model(s) 152 in FIG. 1). Response engine 126 generates responsive content for the request, which includes the responsive natural language content 203B and, if generated, the overlay content 204. Rendering engine 112, which can include tracking module 112A, can receive the responsive natural language content 203B and overlay content 204 and cause the client device 110 to render the responsive natural language content (e.g., audibly and/or visually) and, if overlay content is provided, to render a visual overlay in accordance with the object characterized by the overlay content 204.

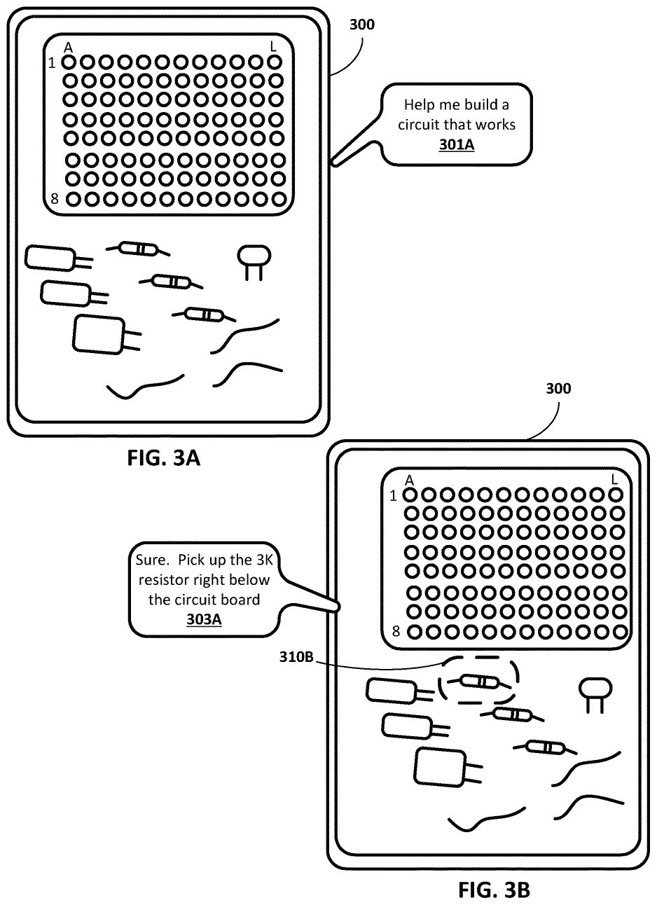

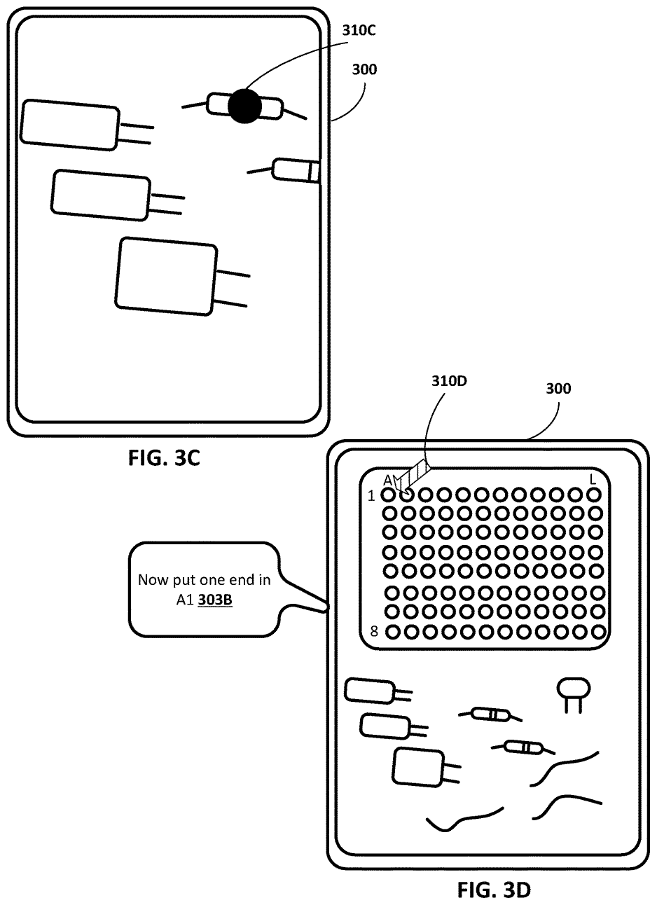

FIGS. 3A, 3B, 3C, and 3D illustrate a client device 300 and part of an example interactive session according to implementations disclosed herein. In the example of FIGS. 3A, 3B, 3C, and 3D, the client device 300 includes a camera and the screen of the client device 300 is displaying a live stream of images from a camera feed of the camera.

FIG. 3A shows an initial state of the environment captured by the camera feed, depicting a circuit board and various electronic components along with a speech bubble indicating a NL user request “Help me build a circuit that works” at 301A. The NL user request 301A and the image (being displayed in FIG. 3A) from the camera feed can be provided as part of a request to response system 120.

FIG. 3B shows a speech bubble at 303A indicating responsive natural language content generated by the response system 120 based on processing the NL user request 301A and the image (being displayed in FIG. 3A). The responsive natural language content is “Sure. Pick up the 3K resistor right below the circuit board” and can be audibly rendered. Notably, FIG. 3B also includes a visual overlay 310B in the form of a bounding shape that encompasses the “3K resistor” in the image of FIG. 3B. Accordingly, the visual overlay 310B highlights the “3K resistor” that corresponds to the object that is the focus of the responsive NL content. In these and other manners, a user is able to quickly ascertain which resistor is the “3K resistor”, obviating the need to analyze color bands on each of the resistors. It is noted that FIG. 3B includes a new image, from the camera feed, relative to the image of FIG. 3A. In the new image the camera has been panned to the left, e.g., due to movement of the client device 300 by the user. Nonetheless, the visual overlay 310B is still encompassing the “3K resistor” due to object tracking that can be performed locally at the client device 300 (e.g., via rendering engine 112 and tracking module 112A).

FIG. 3C shows a new image, from the camera feed, relative to the images of FIGS. 3A and 3B. In the new image, the camera has been zoomed and/or moved closer to some of the electronic components in the environment, including the “3K resistor”. In FIG. 3C the visual overlay 310C is being rendered with visual features that are distinct from those of its rendering in FIG. 3B. More particularly, in FIG. 3C the visual overlay 310C is a dot over the “3K resistor”. The client device 300 (e.g., via rendering engine 112) can adapt the visual features in response to detecting that a size of the “3K resistor” in the image exceeds a threshold size. Adapting the visual features based on the size of the object can ensure the overlay on the object remains easily ascertainable to a user.

FIG. 3D shows a speech bubble at 303B indicating subsequent responsive NL content, generated by the response system 120, of “Now put one end in A1”. FIG. 3D also includes a new visual overlay 310D, in the form of an arrow pointing to the object that is the focus of the subsequent NL content: receptacle A1 on the circuit board. Alternative visual overlays can be utilized, such as a visual overlay that is a rendering of a resistor being inserted into receptacle A1. In FIG. 3D, the response system 120 can generate the subsequent responsive NL content by processing a prompt that includes an updated image, such as the updated image displayed in FIG. 3D, that reflects the “3K resistor” is no longer present. For example, the prompt can include the update image and the dialog history of the interactive session (including that of FIGS. 3A and 3B) to enable generation of responsive NL content that reflects “Now put one end in A1” as the updated image and the dialog history lead to an inference that the user has picked up and is holding the “3K resistor”.

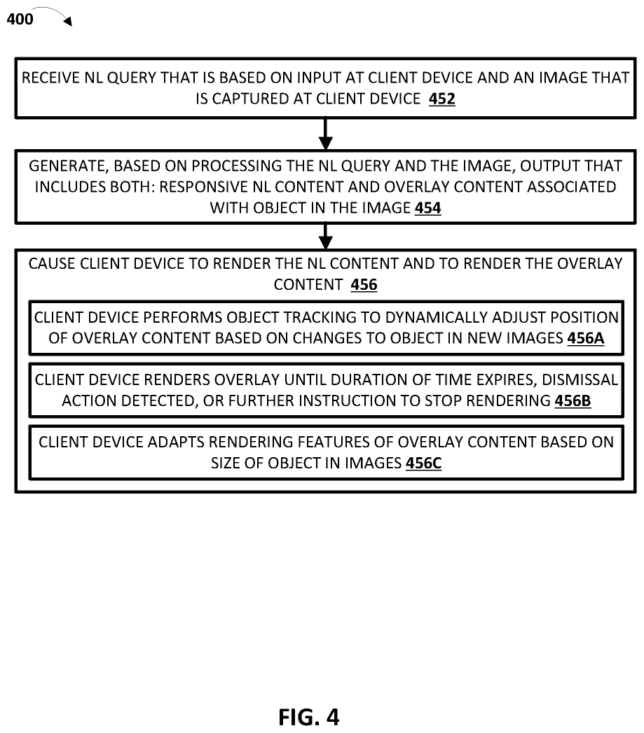

Turning now to FIG. 4, a flowchart illustrating an example method 400 according to implementations described herein is depicted. For convenience, the operations of the method 400 are described with reference to a system that performs the operations. This system may include various components of various computer systems, such as one or more components of the response system 120. Moreover, while operations of the method 400 are shown in a particular order, this is not meant to be limiting. One or more operations may be reordered, omitted or added.

At block 452, the system receives a natural language query that is generated based on user interface input provided via a client device during an interactive session, and receives an image that is captured at the client device during the interactive session. For example, a user might speak the query “Where is the power button?” into their mobile phone, and the phone captures an image of a device being displayed on its screen. The system receives both the spoken query (as text) and the image from the phone.

At block 454, based on processing the natural language query and the image, the system generates output that includes both responsive natural language content and overlay content associated with an object in the image. The system can utilize one or more generative models (e.g., vision language model(s) (VLM(s)) or other multimodal input model) to process the query and image and produce this multimodal output. For instance, in response to the query “Where is the power button?” and the image of the device, the system could generate the responsive natural language content “The power button is on the side” and overlay content specifying the coordinates of the power button in the image.

At block 456, the system causes the client device to render the responsive natural language content and to render the overlay content. For example, the client device might display and/or audibly render “The power button is on the side” and simultaneously render a visual overlay, such as a bounding box or a pulsating dot, directly over the power button in the image being displayed on the screen.

In some implementations, block 456 can include sub-blocks 456A, 456B, and/or 456C.

At sub-block 456A, the client device can perform object tracking to dynamically adjust the position of the overlay content based on changes to the object in new images. If the user moves the device or the client device's camera viewpoint changes, the object's position in the stream of images may change. The client device can track the object and ensure the visual overlay remains correctly positioned over it. For instance, if the user slightly rotates the device, causing the power button to shift its position in the image, the client device's tracking functionality will detect this movement and adjust the bounding box or dot accordingly so that it continues to highlight the power button.

At sub-block 456B, the client device renders the visual overlay until a duration of time expires, a dismissal action is detected, and/or further instruction is received to stop rendering the visual overlay. For example, the visual overlay might automatically disappear after 12 seconds, a user might tap the screen and the visual overlay dismissed in response, or the system might send an instruction to stop rendering the overlay if the user provides a new query.

At sub-block 456C, the client device can adapt the rendering features of the overlay content based on the size of the object in the images. This can enhance the visibility and usability of the overlay depending on how prominent the object is in the user's view. For instance, if the power button appears small in the image (perhaps because the user is far away), the client device might render a large bounding shape as the visual overlay. If the user moves closer, and the power button appears larger in the image, the client device could switch to rendering a small dot over the power button to provide a more precise indication.

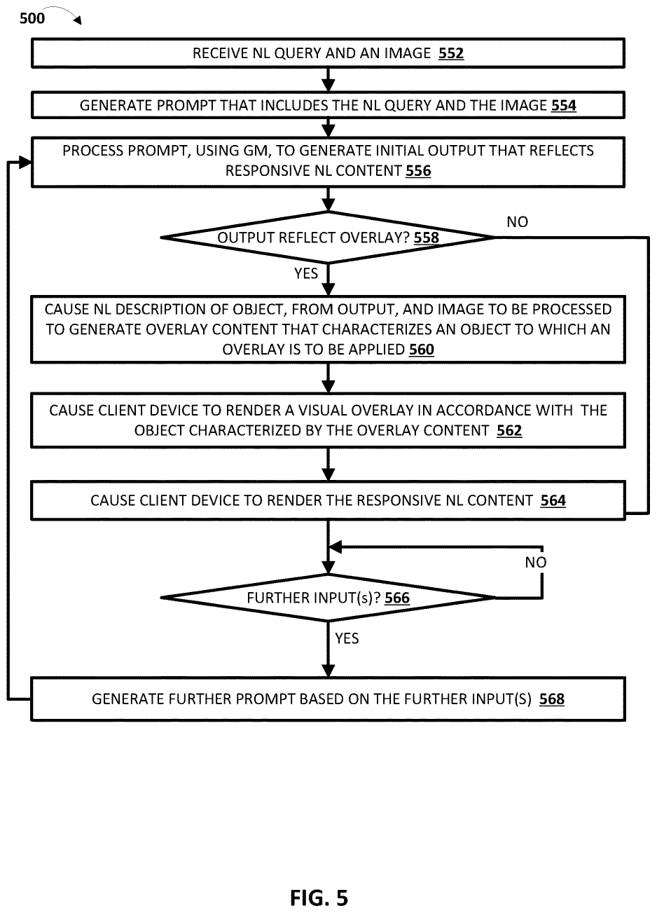

Turning now to FIG. 5, a flowchart illustrating an example method 500 according to implementations described herein is depicted. For convenience, the operations of the method 500 are described with reference to a system that performs the operations. This system may include various components of various computer systems, such as one or more components of the response system 120. Moreover, while operations of the method 500 are shown in a particular order, this is not meant to be limiting. One or more operations may be reordered, omitted or added.

At block 552, the system receives a natural language query and an image. This could occur, for example, when a user points their phone camera at a complex device and asks “What is this part?”. The system receives the spoken query (optionally converted to text) and a still image from the phone's camera feed.

At block 554, the system generates a prompt that includes the natural language query and the image. This prompt serves as input for a generative model. For instance, the generated prompt might combine the user's query text with the image data in a format suitable for processing by a large multimodal model.

At block 556, the system processes the prompt using a generative model (GM) to generate initial output that reflects responsive natural language content and that optionally additionally reflects that an overlay should be provided. For example, if the user asked “What is this part?” while pointing at a specific component on a circuit board in the image, the initial output might be “That appears to be a 3K resistor” and can also indicate that an overlay should be provided (e.g., an object description of “3K resistor” can be provided). The GM used at block 556 can include, for example, a VLM or other multimodal input model.

At block 558, the system determines whether the output of block 554 reflects that an overlay should be provided. For example, whether the output includes an object description or other data indicating that understanding of the NL response would benefit from a visual overlay. If the system determines the output reflects that an overlay should be provided, the method proceeds to block 560 and generates overlay content. In the example above, since the natural language content explicitly identifies a “3K resistor” in the image, the output can indicate that a visual overlay would be beneficial. If, however, the natural language content was something general like “There are many components on this board,” no specific object is identified, and the output would not indicate that a visual overlay would be beneficial.

If the output reflects an overlay, the method moves to block 560. At block 560, the system processes the natural language description of the object from the output (e.g., “3K resistor”) and the image to generate overlay content that characterizes the object to which an overlay is to be applied. This processing can also utilize a generative model, which can be the same as or different than that used at block 556. The output of this step can be overlay content that precisely locates the object within the image, such as pixel coordinates or a bounding box definition. For instance, this step could determine the exact location and boundaries of the 3K resistor in the image.

At block 562, the system causes the client device to render a visual overlay in accordance with the object characterized by the overlay content. For example, when the system is separate from the client device, the system can transmit the overlay content to the client device to cause it to be rendered by the client device. As another example, when the system is executed in whole or in part at the client device, the system can cause the overlay content to be rendered via an application of the client device or via an operating system of the client device. The client device uses the overlay content to render a visual overlay, such as a bounding box, a dot, or an arrow, in association with the identified object in the image being displayed on the screen. Following the example, the client device could draw a box around the 3K resistor.

Regardless of whether an overlay is generated, the system causes the client device to render the responsive natural language content at block 564. The natural language response generated in block 556 is presented to the user, either as text on the screen or via synthesized speech. In the example, the user would see or hear “That appears to be a 3K resistor.”

At block 566, the system checks for further inputs. This allows for continued interaction in the multimodal session. If the user provides additional queries or the system detects relevant changes (e.g., the object moves, a new object is brought into view), the process can return to block 552 with the new input at block 568, potentially generating a new prompt and updated output, including potentially a new overlay or no overlay, depending on the response. For example, the user might then ask “What should I do with it?” while still viewing the circuit board, triggering a new cycle of the method.

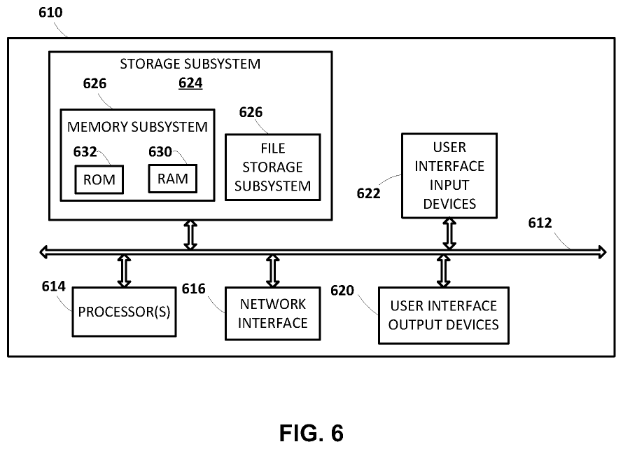

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of method 400, method 300, and/or to implement one or more aspects of response system 120. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a CD-ROM drive, an optical drive, or removable media cartridges. Modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple buses.

Computer system 610 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In some implementations, a method implemented by processor(s) is provided and includes receiving a natural language query and an image. The natural language query is generated based on user interface input provided via a client device during an interactive session. The image is a screenshot of an interface being rendered by the client device during the interactive session or captured by a camera of the client device during the interactive session. During the interactive session and in response to receiving the natural language query and the image, generating, based on processing the natural language query and the image and using one or more generative models, output that includes both responsive natural language content that is responsive to the natural language query and overlay content that characterizes an object to which a visual overlay is to be applied. Causing the client device to render, responsive to the natural language query, the responsive natural language content and the visual overlay. The visual overlay is rendered at the client device in accordance with the object characterized by the overlay content and is rendered over the interface or is rendered over a rendered stream of images captured by the camera.

These and other implementations of the technology disclosed herein can include one or more of the following features.

In some implementations, generating the output can include generating an initial prompt that includes the natural language query and the image. The initial prompt can be processed, using a generative model of the one or more generative models, to generate initial output that can reflect the responsive natural language content and that can reflect a natural language description of an object that can be in the image and that can be addressed by the natural language content. In some of those implementations, in response to the initial output reflecting the natural language description of the object in the image, the natural language description of the object in the image and the image can be processed, using the generative model or an additional generative model, of the one or more generative models, to generate the overlay content that can characterize the area to which the visual overlay is to be applied. In some versions of those implementations, generating the initial prompt can include including, in the initial prompt, instructional language to generate a description of an object that can be in the image and that can be addressed by the natural language content, the instructional language being in addition to the natural language query.

In some implementations, generating the output can include generating a prompt that includes the natural language query and the image. The prompt can be processed, using a generative model of the one or more generative models, to generate output that can reflect both the responsive natural language content and the overlay content. In some of those implementations, generating the prompt can include: including, in the prompt, instructional language to generate overlay content that can characterize an object that can be in the image and that can be addressed by the natural language content, the instructional language being in addition to the natural language query.

In some implementations, the image can be captured by the camera of the client device during the interactive session and wherein the client device can render the visual overlay over the object in the rendered stream of images, wherein the rendered stream of images can be captured by the camera subsequent to capturing the image. In some of those implementations, in rendering the visual overlay, the client device can utilize the object that can be characterized by the overlay content in tracking the object in the images of the stream and can render the visual overlay in accordance with the tracking of the object. In some versions of those implementations, in tracking the object, the client device can utilize marker-less tracking or marker-based tracking.

In some implementations, the client device, while rendering the visual overlay, can monitor for occurrence of the object no longer being present in the interface or the stream of images. In some of those implementations, the client device, in response to detecting that the object no longer being present in the interface, the stream of images, or the camera, can cease rendering the visual overlay.

In some implementations, the client device, while rendering the visual overlay, can monitor for occurrence of expiration of a duration of time that the visual overlay has been rendered. In some of those implementations, the client device, in response to detecting that the duration of time has expired, can cease rendering the visual overlay.

In some implementations, the client device, while rendering the visual overlay, can monitor for occurrence of a dismissal user interface input that can be directed to the visual overlay. In some of those implementations, the client device, in response to detecting that the dismissal user interface input has occurred, can cease rendering the visual overlay.

In some implementations, the client device can detect a size of the object in the interface or the stream of images and can render the visual overlay with first visual features when the detected size of the object satisfies a threshold size and can render the visual overlay with second visual features when the detected size of the object does not satisfy the threshold size. In some of those implementations, rendering the visual overlay with the first visual features can include rendering a bounding shape that encompasses the object without simultaneously rendering a dot over the object, and wherein rendering the visual overlay with the second visual features can include rendering a dot over the object without simultaneously rendering a bounding shape that encompasses the object.

In some implementations, the visual overlay can comprise a bounding shape that encompasses the object, an arrow pointing to the object, or a dot over the object. In some implementations, the visual overlay lacks any natural language content. In some implementations, a visual overlay includes some text (e.g., “here” to denote location of an object), includes an outline of an object (one present or not present in the image), a rendering of an object (one present or not present in the image), and/or other visual content.

In some implementations, causing the client device to render the responsive natural language content and the visual overlay can include transmitting, to the client device, the responsive natural language content and the overlay content.

In some implementations, the overlay content can include a coordinate that corresponds to a pixel of the image. In some of those implementations, the client device can utilize the coordinate and the image to track an object position of the object in the interface of the images of the stream and to dynamically adjust positioning of the visual overlay in accordance with the tracked object position of the object. In some versions of those implementations, the client device can utilize the coordinate and the image in marker-based or marker-less tracking of the object position of the object.

The method can further include while the visual overlay is being rendered at the client device, and during the interactive session, receiving an additional natural language query and an additional image, the additional natural language query being generated based on additional user interface input provided via the client device, and the additional image being an additional screenshot of the interface being rendered by the client device during the interactive session or being captured by the camera of the client device during the interactive session. The method can further include during the interactive session and in response to receiving the additional natural language query and the additional image, generating, based on processing the natural language query and the image and using one or more of the generative models, additional output that includes both additional responsive natural language content that can be responsive to the additional natural language query, and additional overlay content that characterizes an additional object to which the visual overlay is to be applied. The method can further include causing the client device to render, responsive to the additional natural language query, the additional responsive natural language content, and the visual overlay, wherein the visual overlay can be rendered at the client device in accordance with the additional object characterized by the overlay content and can be rendered over the interface or can be rendered over a rendered stream of further images captured by the camera.

In some implementations, a method implemented by processor(s) is provided and includes providing a natural language query and an image to a server device during an interactive session. The natural language query is generated based on user interface input provided via the client device during the interactive session. The image is a screenshot of an interface being rendered by the client device during the interactive session or is captured by a camera of the client device during the interactive session. During the interactive session and in response to providing the natural language query and the image, receiving output from the server device. The output is generated based on processing the natural language query and the image and using one or more generative models of the server device. The output includes both responsive natural language content that is responsive to the natural language query and overlay content that characterizes an object to which a visual overlay is to be applied. Rendering, responsive to the natural language query, the responsive natural language content and the visual overlay. The visual overlay is rendered at the client device in accordance with the object characterized by the overlay content and is rendered over the interface or includes rendered over a rendered stream of images captured by the camera.

In some implementations, the image can be captured by the camera of the client device during the interactive session and rendering the visual overlay can include rendering the visual overlay over the object in the rendered stream of images, wherein the rendered stream of images can be captured by the camera subsequent to capturing the image. In some of those implementations, rendering the visual overlay can include utilizing the object that can be characterized by the overlay content in tracking the object in the images of the stream and can render the visual overlay in accordance with the tracking of the object. In some versions of those implementations, tracking the object can include utilizing marker-less tracking or marker-based tracking.

In some implementations, the method can further include monitoring, while rendering the visual overlay, for occurrence of the object no longer being present in the interface or the stream of images; and in response to detecting that the object no longer being present in the interface, the stream of images, or the camera, ceasing rendering the visual overlay.

In some implementations, the method can further include monitoring, while rendering the visual overlay, for occurrence of expiration of a duration of time that the visual overlay has been rendered; and in response to detecting that the duration of time has expired, ceasing rendering the visual overlay.

In some implementations, the method can further include monitoring, while rendering the visual overlay, for occurrence of a dismissal user interface input that can be directed to the visual overlay; and in response to detecting that the dismissal user interface input has occurred, ceasing rendering the visual overlay.

In some implementations, the method can further include detecting a size of the object in the interface or the stream of image; wherein rendering the visual overlay can include rendering the visual overlay with first visual features when the detected size of the object satisfies a threshold size and rendering the visual overlay with second visual features when the detected size of the object does not satisfy the threshold size. In some versions of those implementations, rendering the visual overlay with the first visual features can include rendering a bounding shape that encompasses the object without simultaneously rendering a dot over the object, and wherein rendering the visual overlay with the second visual features can include rendering a dot over the object without simultaneously rendering a bounding shape that encompasses the object.

In some implementations, the visual overlay can include a bounding shape that encompasses the object, an arrow pointing to the object, or a dot over the object.

In some implementations, the overlay content can include a coordinate that corresponds to a pixel of the image.

In some implementations, rendering the visual overlay can include utilizing the coordinate and the image to track an object position of the object in the interface of the images of the stream and to dynamically adjust positioning of the visual overlay in accordance with the tracked object position of the object.

In addition, some implementations include one or more processors (e.g., central processing unit(s) (CPU(s)), graphics processing unit(s) (GPU(s)), and/or tensor processing unit(s) (TPU(s)) of one or more computing devices, where the one or more processors are operable to execute instructions stored in associated memory, and where the instructions are configured to cause performance of any of the methods disclosed herein. Some implementations include one or more computer-readable storage media (e.g., transitory and/or non-transitory) storing computer instructions executable by one or more processors to perform any of the methods disclosed herein. Some implementations include a computer program product including instructions executable by one or more processors to perform any of the disclosed herein.

We claim:

1. A method implemented by one or more processors, the method comprising:
receiving a natural language query and an image, the natural language query being generated based on user interface input provided via a client device during an interactive session, and the image being a screenshot of an interface being rendered by the client device during the interactive session or being captured by a camera of the client device during the interactive session;
during the interactive session and in response to receiving the natural language query and the image:
generating, based on processing the natural language query and the image and using one or more generative models, output that includes both:
responsive natural language content that is responsive to the natural language query, and
overlay content that characterizes an object to which a visual overlay is to be applied;
causing the client device to render, responsive to the natural language query:
the responsive natural language content, and
the visual overlay, wherein the visual overlay is rendered at the client device in accordance with the object characterized by the overlay content and is rendered over the interface or is rendered over a rendered stream of images captured by the camera.

2. The method of claim 1, wherein generating the output comprises:
generating an initial prompt that includes the natural language query and the image;
causing the initial prompt to be processed, using a generative model of the one or more generative models, to generate initial output that reflects the responsive natural language content and that reflects a natural language description of an object that is in the image and that is addressed by the natural language content; and
in response to the initial output reflecting the natural language description of the object in the image:
causing the natural language description of the object in the image and the image to be processed, using the generative model or an additional generative model, of the one or more generative models, to generate the overlay content that characterizes the area to which the visual overlay is to be applied.

3. The method of claim 2, wherein generating the initial prompt comprises including, in the initial prompt, instructional language to generate a description of an object that is in the image and that is addressed by the natural language content, the instructional language being in addition to the natural language query.

4. The method of claim 1, wherein generating the output comprises:
generating a prompt that includes the natural language query and the image; and causing the prompt to be processed, using a generative model of the one or more generative models, to generate output that reflects both:
the responsive natural language content, and
the overlay content.

5. The method of claim 4, wherein generating the prompt comprises including, in the prompt, instructional language to generate overlay content that characterizes an object that is in the image and that is addressed by the natural language content, the instructional language being in addition to the natural language query.

6. The method of claim 1, wherein the image is captured by the camera of the client device during the interactive session and wherein the client device renders the visual overlay over the object in the rendered stream of images, wherein the rendered stream of images are captured by the camera subsequent to capturing the image.

7. The method of claim 6, wherein in rendering the visual overlay, the client device utilizes the object that is characterized by the overlay content in tracking the object in the images of the stream and renders the visual overlay in accordance with the tracking of the object.

8. The method of claim 7, wherein in tracking the object, the client device utilizes marker-less tracking or marker-based tracking.

9. The method of claim 1,
wherein the client device, while rendering the visual overlay, monitors for occurrence of the object no longer being present in the interface or the stream of images; and
wherein the client device, in response to detecting that the object no longer being present in the interface, the stream of images, or the camera, ceases rendering the visual overlay.

10. The method of claim 1,
wherein the client device, while rendering the visual overlay, monitors for occurrence of expiration of a duration of time that the visual overlay has been rendered; and
wherein the client device, in response to detecting that the duration of time has expired, ceases rendering the visual overlay.

11. The method of claim 1,
wherein the client device, while rendering the visual overlay, monitors for occurrence of a dismissal user interface input that is directed to the visual overlay; and
wherein the client device, in response to detecting that the dismissal user interface input has occurred, ceases rendering the visual overlay.

12. The method of claim 1,
wherein the client device detects a size of the object in the interface or the stream of images and renders the visual overlay with first visual features when the detected size of the object satisfies a threshold size and renders the visual overlay with second visual features when the detected size of the object does not satisfy the threshold size.

13. The method of claim 12,
wherein rendering the visual overlay with the first visual features includes rendering a bounding shape that encompasses the object without simultaneously rendering a dot over the object, and
wherein rendering the visual overlay with the second visual features includes rendering a dot over the object without simultaneously rendering a bounding shape that encompasses the object.

14. The method of claim 1, wherein the visual overlay comprises a bounding shape that encompasses the object, an arrow pointing to the object, or a dot over the object.

15. The method of claim 1, wherein causing the client device to render the responsive natural language content and the visual overlay comprises:
transmitting, to the client device, the responsive natural language content and the overlay content.

16. The method of claim 1, wherein the overlay content includes a coordinate that corresponds to a pixel of the image.

17. The method of claim 16, wherein the client device utilizes the coordinate and the image to track an object position of the object in the interface of the images of the stream and to dynamically adjust positioning of the visual overlay in accordance with the tracked object position of the object.

18. The method of claim 1, further comprising:
while the visual overlay is being rendered at the client device, and during the interactive session, receiving an additional natural language query and an additional image, the additional natural language query being generated based on additional user interface input provided via the client device, and the additional image being an additional screenshot of the interface being rendered by the client device during the interactive session or being captured by the camera of the client device during the interactive session;
during the interactive session and in response to receiving the additional natural language query and the additional image:
generating, based on processing the natural language query and the image and using one or more of the generative models, additional output that includes both:
additional responsive natural language content that is responsive to the additional natural language query, and
additional overlay content that characterizes an additional object to which the visual overlay is to be applied;
causing the client device to render, responsive to the additional natural language query:
the additional responsive natural language content, and
the visual overlay, wherein the visual overlay is rendered at the client device in accordance with the additional object characterized by the overlay content and is rendered over the interface or is rendered over a rendered stream of further images captured by the camera.

19. The method of claim 1, further comprising:
while the visual overlay is being rendered at the client device, and during the interactive session, receiving an additional natural language query and an additional image, the additional natural language query being generated based on additional user interface input provided via the client device, and the additional image being an additional screenshot of the interface being rendered by the client device during the interactive session or being captured by the camera of the client device during the interactive session;
during the interactive session and in response to receiving the additional natural language query and the additional image:
generating, based on processing the natural language query and the image and using one or more of the generative models, additional output that includes both:
additional responsive natural language content that is responsive to the additional natural language query, and
an indication that a visual overlay is not to be applied;
causing the client device to, responsive to the additional natural language query:
render the additional responsive natural language content, and
cease rendering of the visual overlay.

20. A method implemented by one or more processors of a client device, the method comprising:
providing a natural language query and an image to a server device during an interactive session, the natural language query generated based on user interface input provided via the client device during the interactive session, and the image being a screenshot of an interface being rendered by the client device during the interactive session or being captured by a camera of the client device during the interactive session;
during the interactive session and in response to providing the natural language query and the image:
receiving output from the server device, the output generated based on processing the natural language query and the image and using one or more generative models of the server device, the output including both:
responsive natural language content that is responsive to the natural language query, and
overlay content that characterizes an object to which a visual overlay is to be applied;
rendering, responsive to the natural language query:
the responsive natural language content, and
the visual overlay, wherein the visual overlay is rendered at the client device in accordance with the object characterized by the overlay content and is rendered over the interface or is rendered over a rendered stream of images captured by the camera.
